(19) United States
(12) Patent Application Publication
(10) Pub. No.: US 2011/0219963 A1
(43) Pub. Date: Sep. 15, 2011

(54) FRAME PRESS WITH GUIDE COLUMNS

(76) Inventors: Klaus Schuermann, Juechen (DE); Lothar Sebastian, Duisburg (DE); Klaus Wollny, Krefeld (DE)

(21) Appl. No.: 13/064,000

(22) PCT Filed: Sep. 17, 2009
(86) PCT No.: PCT/EP2009/006717

§ 371 Date: May 19, 2011

(30) Foreign Application Priority Data
Sep. 22, 2008 (DE) 10 2008 048 393.1

(51) Int. Cl. B30B 1/23

(52) U.S. Cl. 100/269.01

(57) ABSTRACT

The invention relates to a frame press having a plurality of press frames (1) arranged one after the other, wherein at least one stationary press plate (2) is present and furthermore a press plate (2) is provided which is loaded by means of working cylinder piston arrangements (3) and which can be moved against the stationary press plate (2). On two opposite outer sides (8) of the press, at least two guide columns (5) arranged at a distance to each other are provided, respectively, and each guide column (5) is guided through at least one associated guide opening or through at least one associated guide channel (6) when the press plate (4) which can be moved is moved.

The invention relates to a frame press, in particular, a single-daylight press having row of press frames.

Hydraulic presses are either in the form of frame presses or column presses. Relative to column presses, frame presses have the advantage that they are almost maintenance-free. On the other hand, frame presses must resist relatively high horizontal forces in addition to vertical pressing forces, and the horizontal forces can cause problems.

In contrast, it is the object of the invention to provide a frame press of the above-mentioned type in which horizontal forces are effectively assimilated or absorbed, and, in particular, can be kept away from the press frames.

To attain this object, the invention teaches a frame press, in particular, a single-daylight press, comprising a row of press frames, wherein
at least one fixed lower press platen is provided on a press table and furthermore an upper press platen is provided that is movable by piston-cylinder assemblies against the fixed press platen,
at least two spaced vertical guide columns are each provided on at least two opposite outer ends of the press, and
each vertical guide column is moved through at least one respective guide opening, preferably through at least one respective guide channel, when the movable press platen is moved against the fixed press platen.

It is thus within the scope of the invention to provide a hydraulic press that is a frame press having a plurality of press frames. It is furthermore within the scope of the invention for the guide columns or the respective guide openings or channels to be located at opposite outer ends of the press, and in particular, to be at the four corners or near the four outer corners of the press. At least one, preferably only one, guide column is at each corner or outer corner of the press.

It is recommended that the guide columns or the respective guide openings or channels be on press frames at opposite ends of the press—in particular and preferably, on two outer faces of these end press frames. The guide columns here advantageously extend parallel to the end press frames. The guide columns and the respective guide openings or channels are preferably provided in the region of the outer faces of the two end press frames of the frame press. It is recommended that the frame press according to the invention have at least three, preferably at least four, and very preferably more than five press frames in a row one after the other.

In a first preferred embodiment, the guide columns are moved with the movable press platen and extend through guide openings or guide channels that are preferably mounted or fixed relative to the fixed press platen. In a recommended embodiment, a guide bracket is provided in the region of the fixed press platen, the guide bracket extending at least across the greater part of the width of the respective end press frame. The guide channels for the guide columns are then provided in this stationarily fixed guide bracket. In addition, an upper guide bracket is preferably provided in the region of the movable press platen, which guide bracket extends across at least the greater part of the respective end press frame and is fixedly secured to the guide columns. By moving this upper guide bracket with the movable press platen, the guide columns thus also move and are advantageously guided through the guide channels of the lower fixed guide bracket. It is recommended that these guide brackets be provided on both opposite or outer ends of the press.

In an alternative similarly preferred embodiment of the invention, guide openings or guide channels are provided preferably on the movable press platen and these guide openings or guide channels are movable with the movable press platen and the fixed guide columns move through them when the press platen is moved. The guide columns are then advantageously fixed in place or stationarily fixed relative to the lower fixed press platen. Here too, it is advantageous to work with two respective guide brackets on each of the opposite or outer ends of the press. The guide channels are provided in the upper guide brackets that preferably extend at least across the greater part of the width of the respective press frames. It is recommended that the guide columns be stationarily attached to the lower guide brackets, where the lower guide brackets extend at least across the greater part of the width of the respective press frame.

The guide columns are advantageously guided in a complementary manner, and preferably without play or with little play, in the guide openings or guide channels. The guide columns here can be completely or partially enclosed by the walls of the respective guide channels. In the case of an only partially enclosed embodiment, the terms “complementary” and “without play” refer to the enclosed region. In a recommended embodiment of the invention, the guide columns are of rectangular cross-section, and the respective guide openings or channels are also of rectangular or partially rectangular cross-section. The rectangular cross-section of the guide openings or channels is then, as is recommended, only slightly larger than the rectangular cross-section of the guide columns. The guide columns and the guide openings or channels can, however, also be of a cross-sectional form that is round or circular. The guide channels are advantageously designed as open at each of their two end faces, thereby allowing the guide columns to reach completely through the guide channels.

It is within the scope of the invention for an intake and/or an output opening for the pressed material to be provided between at least two guide columns at a respective outer end of the press. The spacing of the guide columns at the outer ends of the press is thus dimensioned with the requirement that it not impair the passage of the pressed material into the interior of the press.

The invention is based on the idea that the design of the frame press according to the invention enables horizontal forces to be absorbed in a functionally reliable and effective manner. What is achieved in particular is that the horizontal forces can be kept away from the press frames, and essentially dissipated in the guide system consisting of guide columns and guide channels or brackets. Horizontal forces of up to 20 MN can be absorbed or taken up by the arrangement according to the invention. As a result, the horizontal forces can be effectively separated from the longitudinal or vertical forces. The invention is furthermore based on the idea that the absorption of the horizontal forces can essentially be implemented very effectively by a four-point guide system at the corners or outer corners of the press. The point to be emphasized here is that these considerable advantages are achieved by measures that are relatively simple and inexpensive. Neither a significant increase in weight nor a significant increase in volume are required relative to known frame presses. The frame press according to the invention can be produced relatively cost-effectively, and the transport cost for this type of apparatus is relatively low. The frame press according to the invention is distinguished not only by high functional reliability but also long service life.

The following discussion describes the invention in more detail based on a drawing of only one embodiment. Therein:

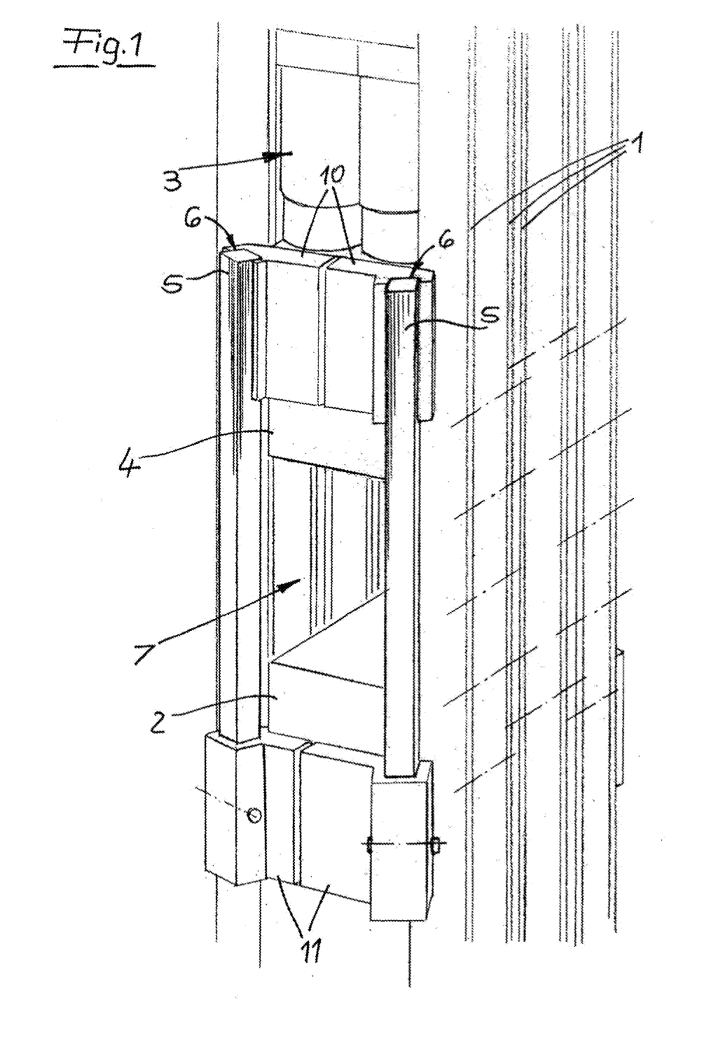

FIG. 1 is a perspective schematic view of the frame press according to the invention, and

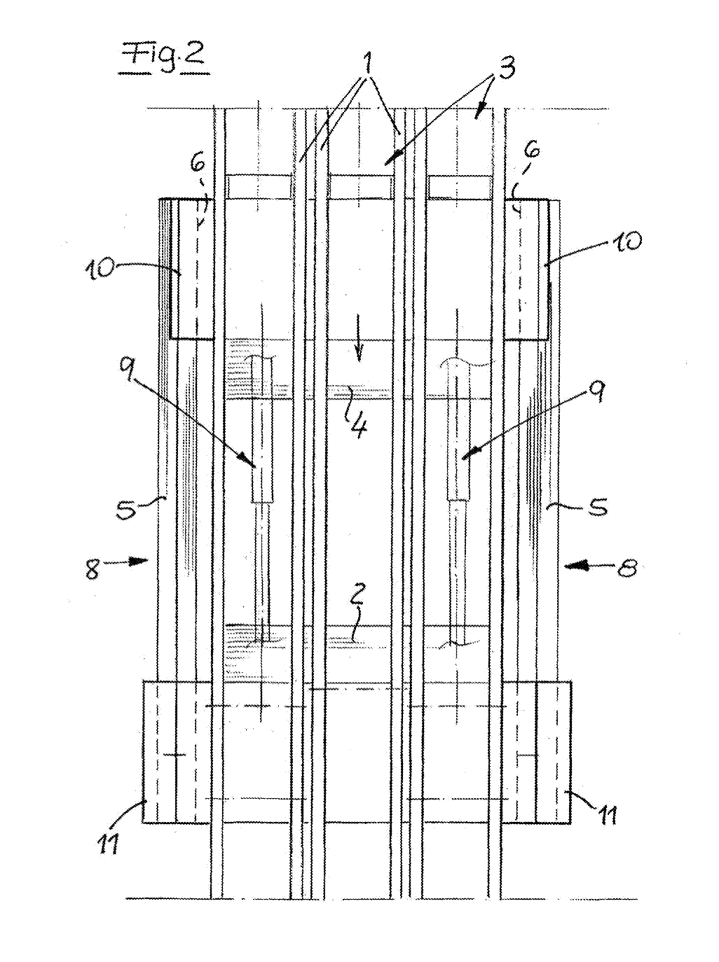

FIG. 2 is a schematic side view of the structure shown in FIG. 1.

The figures show a frame press in the form of a single-daylight press for pressing a flat workpiece. The frame press has a plurality of press frames 1 in a row one after the other in the longitudinal direction of the press. Six of the press frames 1 are provided in this embodiment. A fixed lower press platen 2 is provided, and also an upper press platen 4 is provided that is movable the piston-cylinder assemblies 3 against the fixed press platen 2. In the side view of FIG. 2, piston-cylinder assemblies 9 are shown that extend between the two press platens 2 and 4, the piston-cylinder assemblies functioning in the conventional and familiar fashion to open the press or to exert a predetermined opposite force.

Two vertical and transversely spaced guide columns 5 are provided on the ends of the press, or on the two press frames 1 at opposite ends of the press. On shifting of the press platen 4 relative to the fixed press platen 2, each guide column 5 is guided, preferably and in the embodiment, along a respective guide channel 6. The guide channels 6 here can be of circumferentially closed form. In one possible embodiment and in the embodiment of the figures, however, the guide channels 6 only extend around part of their circumference. However, it is within the scope of the invention that the guide columns 5 are guided or held within guide channels 6 such that they do not become disengaged from these guide channels 6.

Preferably and in the illustrated embodiment, an upper guide bracket 10 and a lower guide bracket 11 are provided on each of the two end press frames 1. The guide brackets 10 and 11 extend transversely across the width or across the greater part of the width of the respective press frames 1. The guide brackets 10 and 11 are advantageously fixed to the press by pretensioned fasteners, in particular, pretensioned bolts. In this embodiment, the lower guide brackets 11 are fixed relative to the fixed lower press platen 2. Preferably and in this embodiment, the guide columns 5 are fixed in a stationary manner to these lower guide brackets 11. Relative motion is therefore no longer possible between the guide columns 5 and the lower guide brackets 11 in this embodiment. In this embodiment based on the figures, the upper guide bracket 10 is fixed relative to the upper movable press platen 4. The upper guide bracket 10 is able to move downward with the upper movable press platen 4. The guide columns 5 here are guided within the guide channels 6 of the upper guide bracket 10, or the guide columns 5 slide through the guide channels 6 of upper guide bracket 10.

In a preferred embodiment and in the embodiment of the figures, the guide columns 5 are of rectangular cross-section, and the respective guide channels 6 are of rectangular cross-section or partially rectangular cross-section in terms of their regions that enclose the guide columns 5. The guide columns 5 fit complementarily with the guide channels 6.

The spacing between the guide columns 5 is preferably and in this embodiment dimensioned with the requirement that unimpeded passage of the pressed material is possible between the guide columns 5 into the interior of or out of the interior of the press.

The invention is based on the idea that use of the guides according to the invention enables horizontal forces to be taken up or absorbed in a functionally reliable and effective manner at the four outer corners of a frame press.

1. A frame press, in particular, a single-daylight press, comprising a plurality of press frames in a row one behind the other, wherein
at least one fixed press platen is provided,
a press platen is provided that is acted upon by working piston-cylinder assemblies and is movable against the fixed press platen,
at least two vertical and spaced guide columns each are provided at at least two opposite sides or ends of the press, and
each guide column is moveable through at least one respective guide opening or through at least one respective guide channel when the movable press platen is moved against the fixed press platen.

2. The frame press according to claim 1, wherein the guide columns or the respective guide openings or guide channels are provided on two press frames at opposite ends of the press.

3. The frame press according to one of claim 1, wherein the guide columns are moved with the movable press platen and extend through guide openings or guide channels in the region of the fixed press platen.

4. The frame press according to one of claim 1, wherein guide openings or guide channels for the guide columns are provided preferably in the region of the movable press platen, which guide openings or guide channels are movable with the movable press platen along the fixed guide columns when the press platen is moved.

5. The frame press according to claim 1, wherein the guide columns are of rectangular cross-section, and the respective guide openings or guide channels are also of rectangular cross-section.

6. The frame press according to claim 1, wherein an intake opening and/or an output opening for the pressed material is formed between at least two guide columns.
